(19) United States
(12) Patent Application Publication
(10) Pub. No.: US 2017/0052944 A1
(43) Pub. Date: Feb. 23, 2017

(54) CONTENT DIGITIZATION AND DIGITIZED CONTENT CHARACTERIZATION SYSTEMS AND METHODS

(71) Applicant: YP-IT LTD., Ottawa, (CA)

(72) Inventors: Omar Hussain Choudhry, Ottawa (CA); Frank O'Dea, Ottawa (CA); Donald Matthew Rankin Ferguson, Carp (CA)

(73) Assignee: YO-IT LTD., Ottawa, ON (CA)

(21) Appl. No.: 15/112,803

(22) PCT Filed: Jan. 16, 2015
(86) PCT No.: PCT/CA2015/050033

§ 371 Date: Aug. 24, 2016

(30) Foreign Application Priority Data
Jan. 20, 2014 (CA) 2839761

(51) Int. Cl. G06F 17/24; G06F 17/30; G06K 9/62; G06K 9/00

(52) U.S. Cl. CPC G06F 17/248; G06K 9/00442; G06F 17/30011; G06K 9/00469; G06K 9/6232; G06K 9/6202; G06K 2209/01

(57) ABSTRACT

Described are various embodiments of a content digitization and digitized content characterization system and method. For example, digitized content items may have content elements of interest extracted therefrom for remote characterization by a set of system users while mitigating, if not eliminating, concerns as to content privacy, confidentiality and/or security.

### FIELD OF THE DISCLOSURE

The present disclosure relates to content management, and in particular, to content digitization and digitized content characterization systems and methods.

### BACKGROUND

Information is recorded for both personal and commercial purposes to provide a record of events, thoughts, instructions, agreements and observations of individuals and businesses. This information may, for example, take the form of individual pieces of data, an image or a compiled document. The invention of the personal computer in the 1980s, followed by the Internet, mobile devices and related technologies has created an ability to prepare and store information in a digitally formatted file. This computer technology allowed an increasingly larger group of individuals to create and store digitally formatted files every year on digital storage media.

The electronic nature of digital storage media masks the scale of an ever-increasing volume of information and these digitally formatted files, which are retained by businesses, governments and private individuals. It is increasingly difficult to locate a particular file within all the digitally formatted files as a result of the volume of duplicates and multiple edits of a file that are retained on this digital storage media. In addition, work is often conducted by multiple individuals who use their own distinct filing and naming conventions, further complicating the effort to locate the file desired.

Digitally formatted files may be stored as images, commonly as Joint Photographic Experts Group (JPEG) or Tagged Image File Format (TIFF) files, as audio and video, commonly as Moving Picture Experts Group (MPEG) format files, or as documents, commonly as Microsoft Word, Microsoft Excel, Portable Document Format (PDF) files, and so on, or in a database with individual pieces of data stored as records.

Digitally formatted files do not automatically organize themselves into logical structures or convey details about their content in their digital state without additional manipulation efforts. These efforts may include manually encoding or generally characterizing the digital formatted files with lists of keywords and other properties, using Optical Character Recognition (OCR) software to extract data, or developing an organized filing and naming for these files, and so on. As a result, the effort required to catalogue and encode files to increase their value to end users is significant.

For older documents and those with complex layouts, OCR software is not as accurate as human transcribers in identifying abnormal characters and is incapable of using human logic to determine the valid association of various pieces of data. As such, the effort to develop computer software programs to convert or extract data from one particular format into another format, including all necessary testing and verification efforts, is often more costly than having the work completed by human transcribers.

A further consideration is that the confidentiality of personal, corporate and government information is important to protect the rights of the owners of the information. Computer technology allows for the transmission, and re-transmission, of electronic files to individuals globally in a matter of seconds and the placement of these files onto Internet-based websites and other forums for access by anyone. As the volume of digital data increases, so does the need for appropriate safeguards against improper data usages, such as to extort, embarrass, spy, sabotage, steal or otherwise use this data against another person, corporation or government. The importance of safeguarding the confidentiality and privacy of data has thus equally increased to counteract this threat by restricting how data is accessed and the individuals who have access thereto. As such, the effort to catalogue and encode digitally formatted files is further complicated by the need to provide security to protect the privacy and confidentiality of these files while enabling sufficient human resources to have access to these files.

This background information is provided to reveal information believed by the applicant to be of possible relevance. No admission is necessarily intended, nor should be construed, that any of the preceding information constitutes prior art.

### SUMMARY

The following presents a simplified summary of the general inventive concept(s) described herein to provide a basic understanding of some aspects of the invention. This summary is not an extensive overview of the invention. It is not intended to restrict key or critical elements of the invention or to delineate the scope of the invention beyond that which is explicitly or implicitly described by the following description and claims.

A need exists for content digitization and digitized content characterization systems and methods that overcome some of the drawbacks of known techniques, or at least, provides a useful alternative thereto. Some aspects of this disclosure provide examples of such systems and methods.

In accordance with one aspect, there is provided a method for digitally characterizing digitized content, the method comprising: accessing a digitized content item to be characterized; automatically locating one or more designated content elements of interest within said digitized content item; digitally extracting said located one or more designated content elements of interest from said digitized content item; digitally rendering said extracted one or more designated content elements, in at least partial isolation, for systematic characterization by a user; receiving, from said user, input of said systematic characterization for each of said extracted one or more designated content elements; and registering each said systematic characterization as representative of its associated content element of interest to digitally characterize said digitized content item.

In accordance with one such method, the digitized content comprises multiple content items of a same type each having two or more corresponding content elements of interest. The accessing, locating and extracting comprise the steps of: a) accessing a given content item; b) locating a given content element of interest within said given content item; c) extracting said given content element from said given content item; d) repeating steps a) to c) for said given content element of interest for each of said multiple content items; and e) repeating steps a) to d) for each of said corresponding content elements of interest.

In accordance with another such method, the accessing, locating and extracting comprise the steps of: a) accessing a given content item; b) locating and extracting each of said two or more corresponding content elements of interest; and c) repeating steps a) and b) for each of said multiple content items.

In accordance with another aspect, there is provided a system for digitally characterizing digitized content, the system comprising: an intake digital data storage device having stored therein a plurality of digitized content items to be characterized, and a designated template corresponding to said digitized content items defining location of one or more designated content elements of interest therein; a digital content extraction engine operatively coupled to said intake digital storage device, said extraction engine accessing said template to operate on each of said digitized content items to locate and extract therefrom said one or more designated content elements of interest; a communication interface having operative access to said extracted content elements, said communication interface providing user interface access to an at least partially isolated digital rendering of said extracted content elements for systematic characterization; and a digital registry communicatively linked to said communication interface to receive therefrom as input and register each said systematic characterization as representative of its associated content element of interest to digitally characterize said digitized content item.

In accordance with another aspect, there is provided a system for digitally characterizing digitized content, the system comprising: an intake digital data storage device having stored therein a plurality of digitized content items to be characterized; a digital content extraction engine operatively coupled to said intake digital storage device, said extraction engine operating on each of said digitized content items to automatically locate and extract therefrom one or more designated content elements of interest; a communication interface having operative access to said extracted content elements, said communication interface providing user interface access to an at least partially isolated digital rendering of said extracted content elements for systematic characterization; and a digital registry communicatively linked to said communication interface to receive therefrom as input and register each said systematic characterization as representative of its associated content element of interest to digitally characterize said digitized content item.

In accordance with another aspect, there is provided method for securely distributing characterization tasks for a plurality of digitized content items across multiple users, the method comprising: compiling a set of digital content segments for each of the plurality of digitized content items; creating a corresponding array of randomly generated numbers, wherein said corresponding array is sized as a function of a maximum number of segments for any given item and a total number of said digital content items; mapping said digital content segments to said corresponding array to automatically associate a respective one of said randomly generated numbers with each of said segments; providing remote users access to randomly selected content segments to be digitally characterized thereby; associating each input digital characterization with its corresponding content segment; and reconstructing each said set of now digitally characterized digital content segments based on said mapping thereby respectively characterizing each of the plurality of digitized content items.

In accordance with another aspect, there is provided a computer-readable medium having statements and instructions stored therein for implementation by a hardware processor of a computing device in securely distributing characterization tasks for a plurality of digitized content items across multiple users by: compiling a set of digital content elements for each of the plurality of digitized content items; creating a corresponding array of randomly generated numbers, wherein said corresponding array is sized as a function of a maximum number of said content elements for any given item and a total number of said digital content items; mapping said digital content elements to said corresponding array to automatically associate a respective one of said randomly generated numbers with each of said elements; providing remote users access to randomly selected content elements to be digitally characterized thereby via a communication interface; associating each input digital characterization received in response to said providing via said communication interface with its corresponding content element; and reconstructing each said set of now digitally characterized digital content elements based on said mapping thereby respectively characterizing each of the plurality of digitized content items.

In accordance with another aspect, there is provided a system for providing secure onsite digitization of paper records at a record owner's location, the apparatus comprising: a wheeled housing unit sized for transport within an office workspace, said housing having one or more securable compartments for securing therein: an intake digital data storage device; a hardcopy scanning device; and a computing device having a processor operable to implement a content intake interface operatively associated with said scanning device for digitizing hardcopy content items for storage in said digital data storage device.

Other aspects, features and/or advantages will become more apparent upon reading of the following non-restrictive description of specific embodiments, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a diagram of a system architecture for implementation of a content digitization and digitized content characterization process, in accordance with one embodiment of the invention;

FIG. 2 is a flow chart illustrating a process for preparing digitized contents for characterization, in accordance with one embodiment of the invention;

FIG. 3 is a flow chart illustrating a process for generating an encryption key code for use in securely characterizing extracted content elements, in accordance with one embodiment of the invention;

FIG. 4 is a flow chart illustrating a process for mapping the generated encryption key code to extracted content elements to implement secure characterization thereof, in accordance with one embodiment of the invention;

FIG. 5 is a flow chart illustrating a process for preparing extracted content elements for characterization, in accordance with one embodiment of the invention;

FIG. 6 is a flow chart illustrating implementation of a distributed content characterization process, in accordance with one embodiment of the invention;

FIG. 7 is a flow chart illustrating a process for recompiling content elements post-characterization, in accordance with one embodiment of the invention;

FIG. 8 is a diagram of an alternate system architecture for implementation of a content digitization and digitized content characterization process, in accordance with one embodiment of the invention;

FIG. 9 are exemplary screenshots of different digitized content item types to be processed by a digitized content characterization system, in accordance with one embodiment of the invention;

FIG. 10 is an exemplary screenshot of a given content item type overlaid by an exemplary template corresponding thereto defining location of multiple content elements of interest therein for extraction and characterization, in accordance with one embodiment of the invention;

FIG. 11 are side-by-side exemplary screenshots of distinct content item types overlaid by respective exemplary templates corresponding thereto respectively defining location of multiple content elements of interest therein, or groups thereof, for extraction and characterization, in accordance with one embodiment of the invention;

FIG. 12 is a screenshot of the content item type of FIG. 10 with template overlay, shown in association with a corresponding extracted content element encryption array, in accordance with one embodiment of the invention;

FIG. 13 is a screenshot of a distinct content item type with template overlay, shown in association with a corresponding extracted content element encryption array juxtaposed to the encryption array shown in FIG. 12, in accordance with one embodiment of the invention;

FIG. 14 is a graphical representation of a three-dimensional array created as a basis for encrypting all content elements extracted from content items of different types digitized in the context of a full scale content digitization and characterization project, in accordance with one embodiment of the invention;

FIG. 15 is a graphical representation of the three-dimensional array of FIG. 14, showing a set of randomly generated cell identifiers associated therewith, in accordance with one embodiment of the invention;

FIG. 16 is a graphical representation of a two-dimensional array derived from the three-dimensional array of FIG. 15, listing in numeral order the randomly generated cell identifiers and their associated extracted content elements, in accordance with one embodiment of the invention;

FIG. 17 is a graphical representation of the two-dimensional array shown in FIG. 16, expanded to include corresponding auto-encoded segment characterizations, in accordance with one embodiment of the invention;

FIG. 18 are exemplary diagrammatical screenshots of successive user interfaces implemented during user characterization of extracted content elements, in accordance with one embodiment of the invention;

FIG. 19 is a diagrammatical representation of a defragmentation and recompilation process post-characterization for associating input digital user characterizations with corresponding originating digitized content items, in accordance with one embodiment of the invention;

FIGS. 20A and 20B are front perspective and side views, respectively, of a mobile unit for onsite content digitization, in accordance with one embodiment of the invention; and

FIG. 21 is a front perspective view of an internal layout of the mobile unit of FIG. 20A, in accordance with one embodiment of the invention.

### DETAILED DESCRIPTION

In accordance with some aspects of the herein-described embodiments, certain technical challenges in content digitization and digitized content characterization may be overcome. For example, some aspects allow for the effective and secure digital characterization of digitized content, for instance in facilitating digital content storage, cataloguing, manipulation, retrieval and/or indexing, to name a few. For instance, some embodiments provide an environment that enables a large number of individuals to systematically process and characterize digitized content items that may have privacy or confidentiality requirements, without compromising the integrity and confidentiality of the content.

As will be described in greater detail below, some embodiments of the herein described systems and methods can provide for the secure manipulation of digitized documents and other information media, generally referred to herein as digitized content items, for instance in characterizing (e.g. encoding, annotating, classifying, categorizing, etc.) private and confidential information contained within these items through systematic characterizing inputs received from a disperse group of individuals, thus protecting the confidential nature of the original content. As will be appreciated by the skilled artisan, while amenable to the processing of private and/or confidential information, if not even possibly classified and/or secret information, embodiments described herein may also be applied to public or other such data that may, or may not be of a particularly sensitive nature.

In some embodiments, digitized content items predominantly comprise existing documents, such as for example, but not limited to, digitized confidential legal documents, medical records, financial records and proprietary information, which can be characterized by designated key content elements to improve the value of the digitized content (e.g. accessibility, retrievability, interlinkability, etc.) while preserving the security and confidentiality of the original content.

In some embodiments, the digitized content items predominantly comprise existing audio and video files, such as for example, but not limited to, voice recordings, conference call recordings and video recorded meetings, which can be characterized by designated key recording interval elements to improve the value of the digitized content (e.g., transcription, retrievability, accessibility, etc.) while preserving the security and confidentiality of the original content.

Accordingly, some embodiments may help eliminate, or at least mitigate concerns regarding access to private and confidential information during the process of digitizing and/or characterizing (e.g. cataloguing, encoding, etc.) files within a digital environment.

For example, in one embodiment, the characterization of large volumes of digitized content may be distributed across a large pool of system users not only to improve the efficiency and speed at which such large projects may be completed, but also to maintain a certain level of confidentiality and/or security by showing only one or more elements of any given digitized content item to any single user. Accordingly, the possibility of having any given user piece together any valuable information from what they are presented in the distributed characterization process is limited at best.

In one such example, each digitized content item to be characterized is paired with a corresponding template (e.g. based on content item type, version, etc.) that locates in that item, one or more content elements of interest for characterisation. For instance, a client or patient intake form, legal opinion, medical diagnosis or prognosis, or other such document having a confidential value, may have been filled in manually and later digitized for safe keeping, cataloguing and future reference, for example. In other examples, location of content elements of interest may be defined in a dynamic and sequential manner, whereby a corresponding content element in each of the digitized content items may be iteratively located and extracted in real-time responsive to a digital location thereof being defined using a locating or dynamic template generation tool, as will be described in greater detail below.

In order to improve the digital value of the digitized document, various key content elements may be located, in this example via a global or dynamic template derived from a general outline of the content item of interest, and extracted for characterization. As will be described in greater detail below in the context of illustrated examples, extracted content characterizations may take the form of user annotations, transcriptions and/or confirmations that an automatic character recognition process resulted in an accurate digital transcription of the extracted content, to name a few examples. For instance, the extracted content may be digitally rendered (or graphically rendered for visualization in the context of visually consumable content) for systematic characterization by an end user (e.g. via a private or public network connection, Web interface, locally implemented client application interface, etc.), wherein the input characterization is then associated with the extracted content element in question, and registered as such upon recompiling each extracted content element of interest for each digitized content item in the project, and optionally, accounting for different digitized item types.

As a result, each digitized content item receives a comprehensive characterization based on a selected set of content elements of interest, while preserving the option that only a subset of these elements are viewed by any given user during characterization. For instance, as will be described in greater detail below, content element distribution and recompilation may be governed by a secure content encryption and allocation process to mitigate the possibility of related elements being processed by a same user, or again, of having participants work on elements of information they may be more likely to recognize (e.g. by distributing elements for characterization based on geography, demographics, etc.). In a simplified example, a given user may be tasked with the digital transcription or confirmation of a first name field extracted from a set of digitized content items, while another remote user may be tasked with the digital transcription or confirmation of a date of birth field on these same content items, thus avoiding any one user possibly linking a name and date of birth they may recognize as someone they know. Similarly, content elements extracted from digitized items recognized as originating from a certain geographical area may be distributed for characterization by users in another geographical area. These and other such examples will be described in greater detail below, within the context of the illustrated examples.

Furthermore, in some embodiments, content digitization may be implemented onsite to further mitigate or eliminate privacy concerns, such that, for example, original contents may never leave the originator's site. As will be described in greater detail below, a mobile digitization or content intake unit may be transported to the content owner's workplace and used to digitize contents onsite. Different options for then managing the characterization of the onsite-digitized contents may include, but are not limited to, arranging for the secure physical or network-based transport of the digitized content items back to a processing site, or again arranging for the secure physical or network-based transport of the extracted content items only for remote processing. In the latter scenario, the content owner could ultimately retain the only copy of the then fully digitized content items, while extracted content elements of interest (e.g. as prescribed by an owner facilitated or directed template generation) are transported or communicated for remote processing. In fact, the extracted content elements could be encrypted onsite such that the unique key code required to recompile the extracted content elements is kept by the content owner for onsite use once the secure remote content element characterizations are complete.

These and other examples will be further described below in the context of the illustrated embodiments.

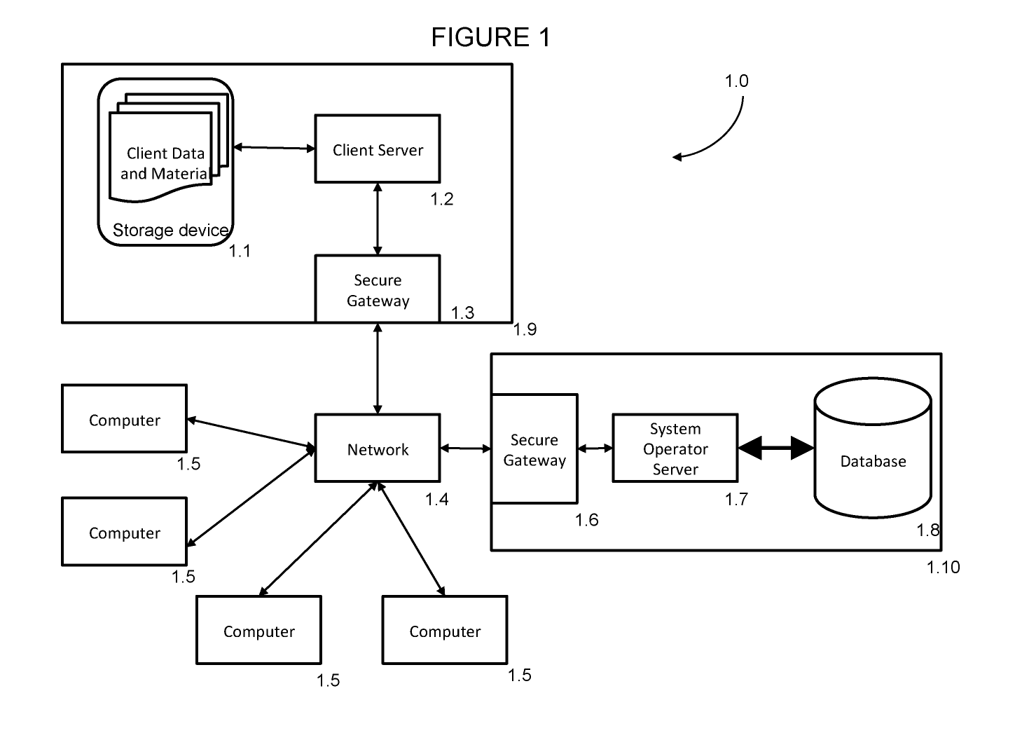

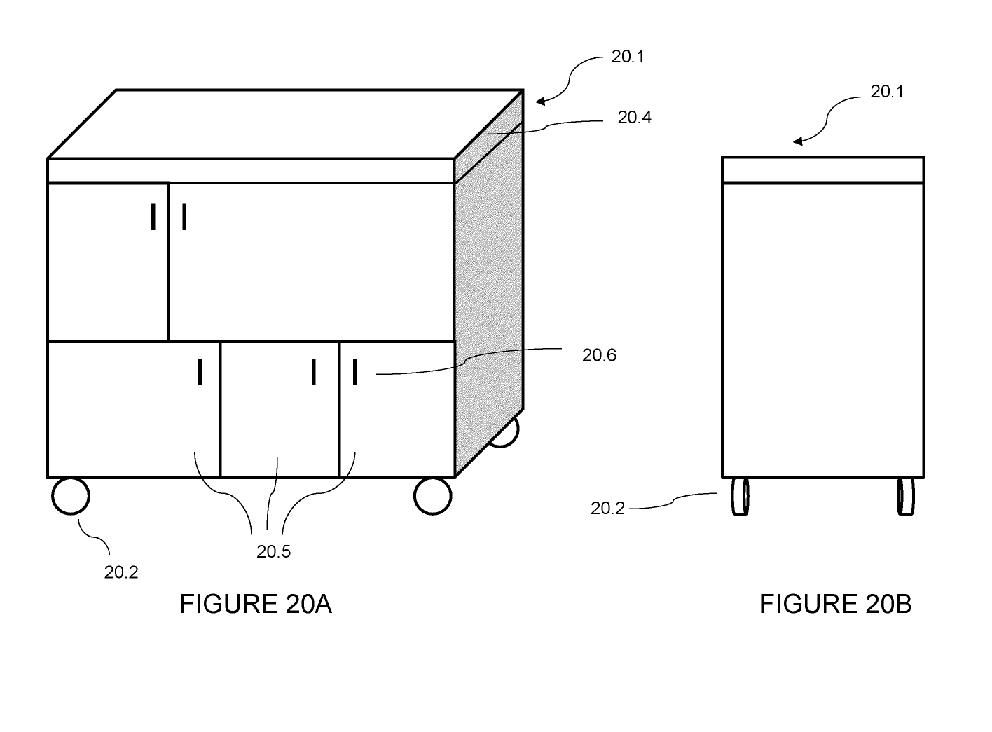

With reference now to FIG. 1, and in accordance with one exemplary embodiment, a content digitization and characterization system, generally referred to using the numeral 1.0, will now be described. The system 1.0 generally comprises a Client private network 1.9, for example established to manage intake of content items for digitization, identification of content elements of interest corresponding thereto, and initiation of the content characterization process. The Client network 1.9 may consist entirely or partially of local hardware and/or equipment available at a content intake location, or again consist at least in part of mobile equipment (e.g. as described in greater detail below with reference to FIGS. 20A, B and 21) delivered at the content intake location by a given service provider or the like for the purpose of delivering an intake, characterization and/or distribution service. The Client private network 1.9 is communicatively linked via network 1.4 to a remote System Operator private network 1.10, which can be implemented to manage the secure content characterization process for each Client, manage a group of users/participants in this process, and possibly also remotely manage or participate in the onsite content intake process, as will be described in greater detail below. End users tasked with the characterization of the digitized content also interface with the system via network 1.4 using respective remote computing platforms (e.g. computers 1.5). As will be appreciated by the skilled artisan, the system may be configured for access by more or less end user computers 1.5 than shown in FIG. 1, as required to support workload, for example. The system may also be configured to service multiple client locations concurrently, for example, by establishing connection between the System Operator private network 1.10 and multiple distinctly implemented Client private networks 1.9.

The network 1.4 used to link the Client private network(s) 1.9, System Operator private network 1.10 and computers 1.5 may be a private network, a public network, or the Internet, to name a few examples. Accordingly, the end user computers may include, but are not limited to, different types of computing platforms such as laptops, desktops, smartphones, tablets, and the like configured for network communication either via a direct network link, dedicated Web interface, or client application interface, to name a few examples. As will be appreciated by the skilled artisan, the network 1.4 may provide the capability to share data and files in an encrypted manner between the Client private network 1.9 and the System Operator private network 1.10, as with each user platform depending on the particular system implementation and privacy requirements thereof. The types, number and other characteristics of the connections can support various configurations, and is well known to people skilled in the art.

In the illustrated embodiment of FIG. 1, the Client private network 1.9 contains a secure gateway 1.3, which in this embodiment may include a secure remote desktop server together with Internet hardware, for example, a modem, a firewall and a router. This network also contains a client server 1.2, which enables access to the client data and electronic materials retained on a storage device 1.1. The storage device may be a hard drive, tape backup, database, or other types of electronic storage device, for example.

Again within the context of the illustrated embodiment, the System Operator private network 1.10 contains a secure gateway 1.6, which in this embodiment may again include a secure remote desktop server together with Internet hardware, for example, a modem, a firewall and a router. This secure gateway enables selected ones of the computing devices 1.5 to display a desktop environment corresponding to that which would be displayed if the computing device were within the System Operator private network 1.10. Suitable such secure remote desktop servers may include, but are not limited to, Citrix XenDesktop™ and Microsoft Remote Desktop Services™. Other user interfaces to the system may also or alternatively be implemented, such as for example, but not limited to, a secure Web interface, dedicated client application interface, and the like, as will be readily appreciated by the skilled artisan. The network 1.10 also contains a client server 1.7 which enables access to business application software used to create, store, process and access a database storage unit 1.8, discussed in greater detail below. Other secure user data access, management and processing architectures may also be considered, as will become readily apparent to the person of ordinary skill in the art.

In the illustrated embodiment, the system operator server 1.7 handles each request received via the secure gateway 1.6 and responds by inserting, modifying or deleting electronic information in the system operator database 1.8, as appropriate. In one exemplary implementation, the system operator database 1.8 can store extracted content elements obtained from the Client's data and materials 1.1 (e.g. digitized content items), processed content or verification data, as well as account information and/or other data appropriate to conduct business.

In one embodiment, the process of inserting electronic data into the system operator database 1.8 may be completed using standard database query language procedures, well known to those skilled in the art.

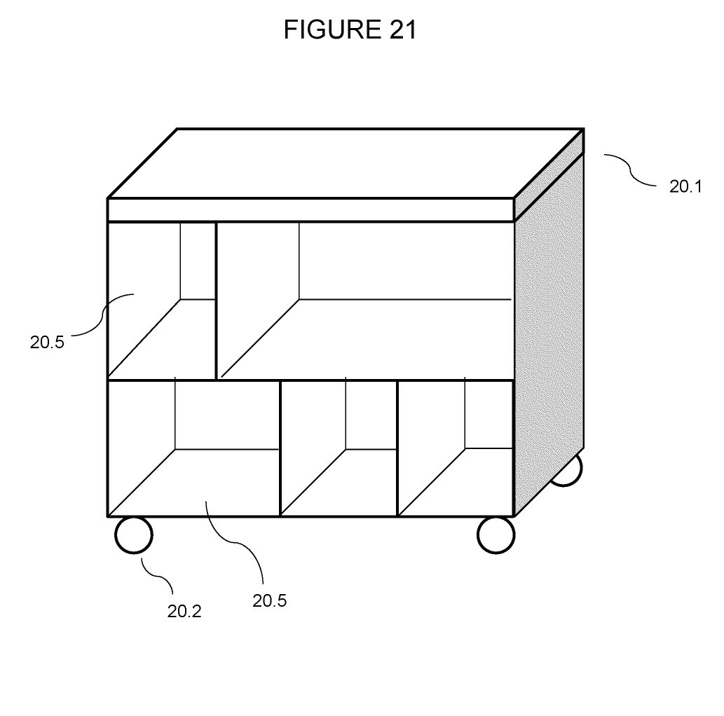

As introduced above, the embodiment illustrated in FIG. 1 is amenable to the provision of a mobile content intake unit in which all necessary content intake hardware may be securely transported to the Client's workspace to process contents onsite. For example, and with reference to FIGS. 20A, 20B and 21, a mobile intake unit will now be described for that purpose, in accordance with one embodiment of the invention. In this example, the unit comprises a housing 20.1 shaped and sized to enable entry into buildings and through office doorways so to deliver the mobile unit to a Client's workspace. The unit further comprises a set of wheels or casters 20.2 allowing for easy transport of the unit to and through the Client's workspace.

As best shown in FIGS. 20A and 21, the unit 20.1 comprises several compartments 20.5 each fitted with their own closures or again commonly fitted with a global closure (not shown), such as a securable front panel or the like. Accordingly, contents stored within the unit may be secured during transport and locked when onsite but not in use. Accordingly, the system operator can access each compartment 20.5 through use of a locking mechanism 20.6 that may restrict access into a compartment 20.5. The style and location of each mechanism 20.6 presented is for display purposes only and are not intended to restrict the embodiment. The size, number and location of each compartment 20.5 are also for illustration purposes only and are not intended to restrict the embodiment to a specific configuration.

In one embodiment, the unit 20.1 may further comprise a cover 20.4 that opens to provide access to interior upper compartments. In some embodiments, the cover 20.4 may be removable and convert into a table for use by the system operator to provide additional workspace.

The dimensions of the unit 20.1 can vary to accommodate the size of included devices required to complete the digitization work required but shall generally still be able to be relocated by non-motorized means into buildings and offices.

With particular reference to FIG. 21, the unit's several compartments may be sized to house various input, output and network access devices (not shown); a computing unit and storage area network device (not shown); consumables and extra cables (not shown); an uninterruptible power supply (not shown); and a scanning device (not shown), for example. The size and location of each compartment are shown for illustration purposes only and are not intended to restrict the embodiments described herein.

The mobile unit 20.1 may contain a computing unit with multiple processors for redundancy and load-sharing capabilities, and that hosts applications necessary to conduct regular business operations and functionality, for example, user password and access control, manipulation of data, digital file manipulation, work product review and auditing, and email correspondence, to name a few. The computing unit will also generally maintain connection with peripheral devices such as the scanner device, the output device, the input device, the network storage device, the network access device and the uninterruptible power supply, for example. The unit 20.1 may further contain a network storage device with multiple hard drives for data storage redundancy and loss-protection.

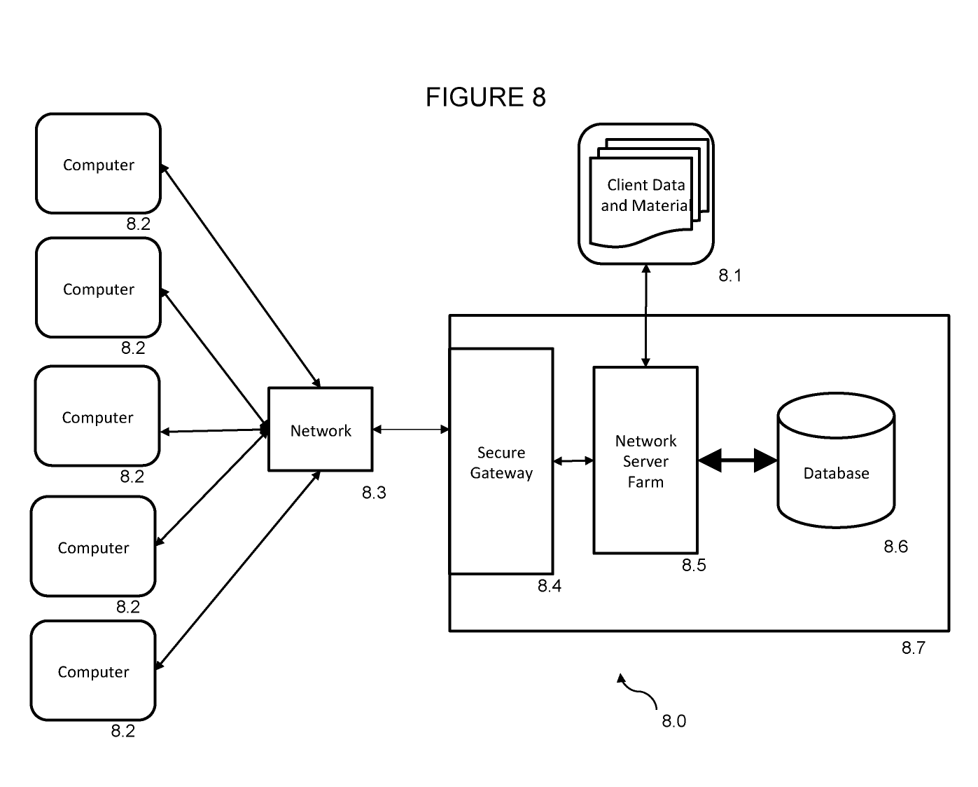

FIG. 8 provides an alternate system architecture 8.0, in accordance with another embodiment of the invention, in which Client data and materials 8.1 are shared with a System Operator private network 8.7 via a Network Server Farm 8.5 or the like. In this embodiment, the Server Farm 8.5 receives digitized content items directly from the Client location via a secure connection, or again via direct delivery of encrypted or otherwise secure data recording media, and implements the content extraction and distribution process offsite. For instance, data may be exchanged with database 8.6 to ultimately characterize the Client's digitized content and return this then characterized data to the Client. User/Participant computers 8.2 may access digitized content elements for characterization through network 8.3 and a Secure Gateway 8.4 implemented by the System Operator private network 8.7.

As will be appreciated by the person of ordinary skill in the art, other system architectures may be considered without departing form the general scope and nature of the present disclosure.

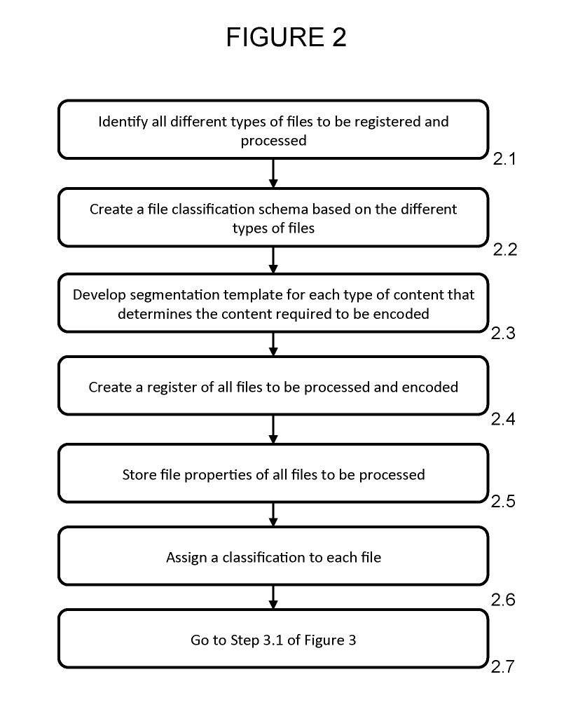

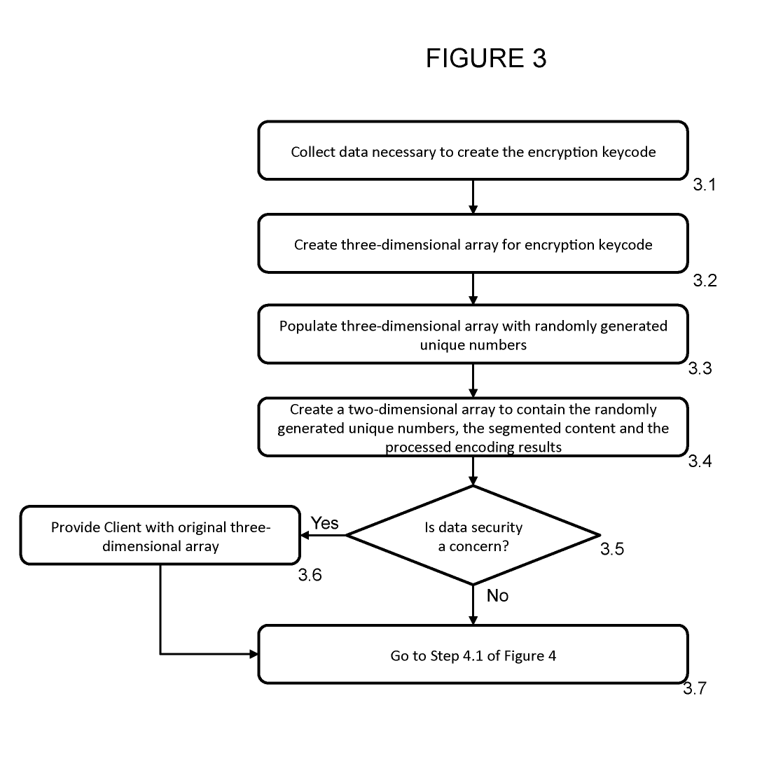

With reference now to FIG. 2, and in accordance with one embodiment, a process for initiating a digitized content characterization process will now be described. In this example, the System Operator and the Client identify at step 2.1 all the different types of files (e.g. documents, forms, images, and/or other such content items) that are to be processed, which provides a file classification schema to be created at step 2.2. The different types of files may include, but are not limited to, digital and/or digitized file types such as different standard forms used within an organization that are completed by their own personnel or by clients, electronic photographs and images, audio and/or video recordings, other electronic documents, and so on. The System Operator and the Client develop at step 2.3 a segmentation template for each type of file to be processed which identifies the manner in which content items corresponding to each such file type will be segmented to protect the required security or confidentiality of the entire file's content when any segment is viewed. For instance, a template generation tool may be digitally executed onsite to generate a digital template for each content item type to locate therein, content elements of interest for extraction and characterization. It is conceivable that some file types will not be segmented and the entire contents of these content item types will be used as a segment/extracted element. The System Operator and the Client create a register at step 2.4 of all the files to be processed. The System Operator stores at step 2.5 the properties of all files/items to be processed in the register and assigns 2.6 the appropriate classification schema to each file/item. The process for generating a key code to be used for encrypting extracted content element relationships will be described with reference to FIG. 3, and is generally referenced as step 2.7.

While in some embodiments, a complete or combined digital template may be predefined for each content type to jointly locate the one or more content elements of interest for a given content item type, as will be described in the example below, in other embodiments, a template generation or content element locating tool may be operated dynamically in sequentially defining such locations for a given content item type, whereby content elements of interest are automatically located and extracted in an iterative manner in response to each location being defined by the locating tool.

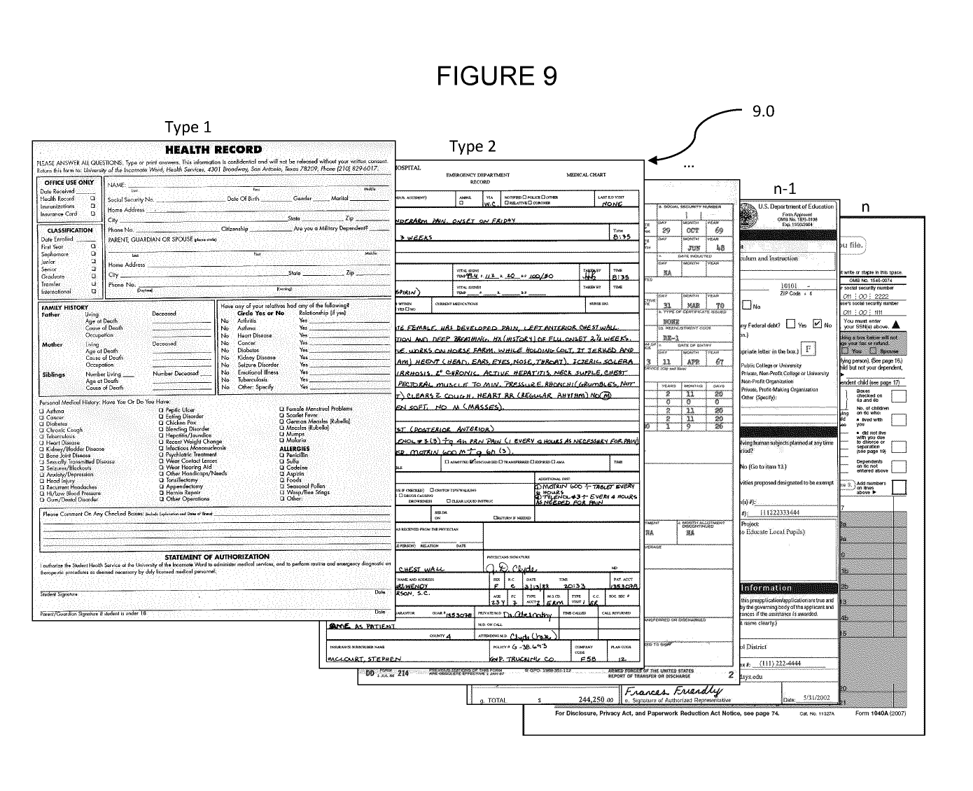

FIG. 9 provides an example in which a set of Health records 9.0 are assembled in a given file of digitized content items of respective file types. As shown in this example, the file consists of different file types, labeled as Type 1, Type 2 . . . Type n−1, and Type n, thus resulting in the establishment of multiple content extraction templates for processing each file, in this example consisting of joint or combined templates to be digitally stored and executed as a whole. It will be appreciated that each template may be effectively generated in a dynamic and iterative manner whereby documents satisfying a given type are processed in real-time concurrent with a dynamic content element locating process.

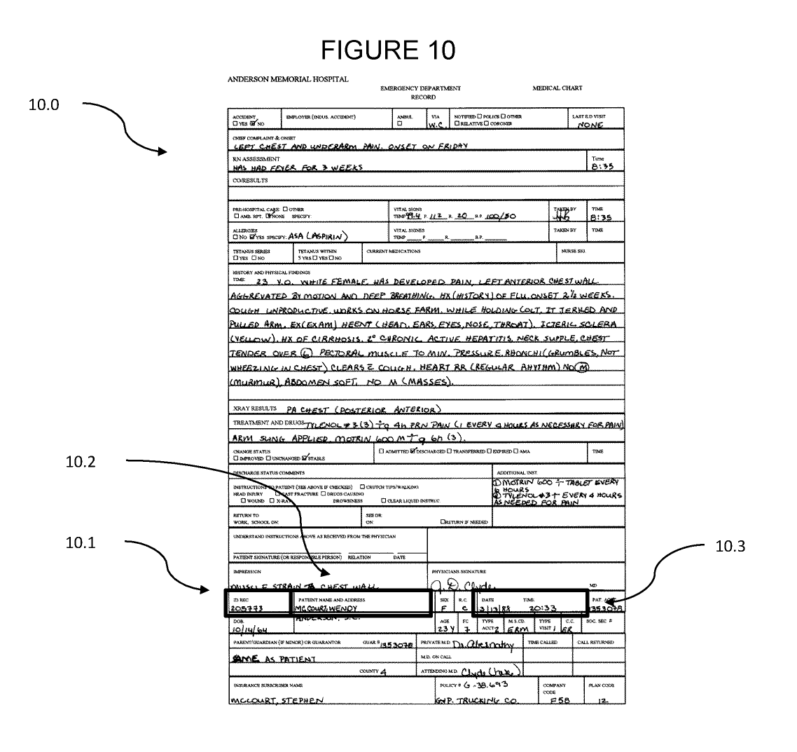

In the example of FIG. 10, a segmentation template is generated in respect of a given file type 10.0, whereby a location of singular content segments 10.1, 10.2 and 10.3 are respectively defined for this file/content item type, and thus useable in systematically extracting these content elements from recurring instances of this file type as the entire project is processed for digitization and characterization.

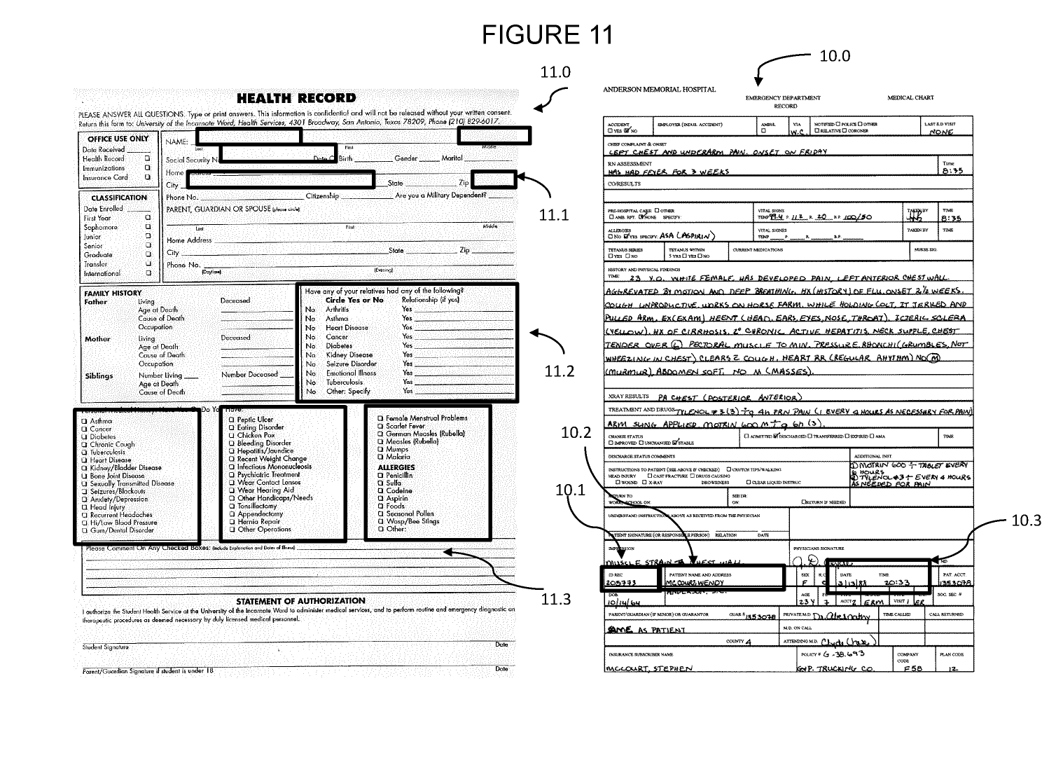

With reference now to FIG. 11, a distinct segmentation template is comparatively generated in respect of another file type 11.0. For this file type, content extraction segments may be grouped for segmentation, whereby the group encompassing unitary segment 11.1 may assemble five (5) data entries, that encompassing unitary segment 11.2 may assemble a data entry list, and that encompassing unitary segment 11.3 may assemble three columns of a manually processed check boxes. Alternatively, and as contemplated in the below-described exemplary key code generation process, each unitary segment can be considered independently as in the example of FIG. 10, so to define 9 independent content elements. As will be appreciated by the skilled artisan, content elements may be of different sizes and shapes, and be of different quantities for different file types, and encompass different types of data, images, content and the like, and that, without departing from the general scope and nature of the present disclosure. Furthermore, the level of content segmentation and process granularity may be varied depending on the nature of the content to be characterized, the sensitivity thereof, and the level of privacy and/or confidentiality that may be required by the task at hand.

In each case, a sample of the digitized content item in question can be digitally rendered for visualization by the content owner or system operator, and a template generation tool (e.g. implemented onsite via a content intake platform and/or offsite via a project management platform) used to create an appropriate template to be used for each recurring instance of this content item type to extract content elements (singular and/or grouped) of interest therefrom for characterization.

With reference now to FIGS. 2 and 3, and in accordance with one embodiment, an exemplary process for encrypting content segment relationships in implementing a secure content characterization process will now be described. In this embodiment, a key code is developed and used to protect content from being recompiled without authorization. Accordingly, the System Operator collects at step 3.1 data from the register (compiled at step 2.4) that identifies the number of files to be included, the number of file types identified by the classification schema created at step 2.2 and the largest number of segments from all segmentation templates as defined at step 2.3. The System Operator then creates at step 3.2 a multi-dimensional array (e.g. three-dimensional array) sized to match the three parameters, in this example, collected from the register at step 3.1.

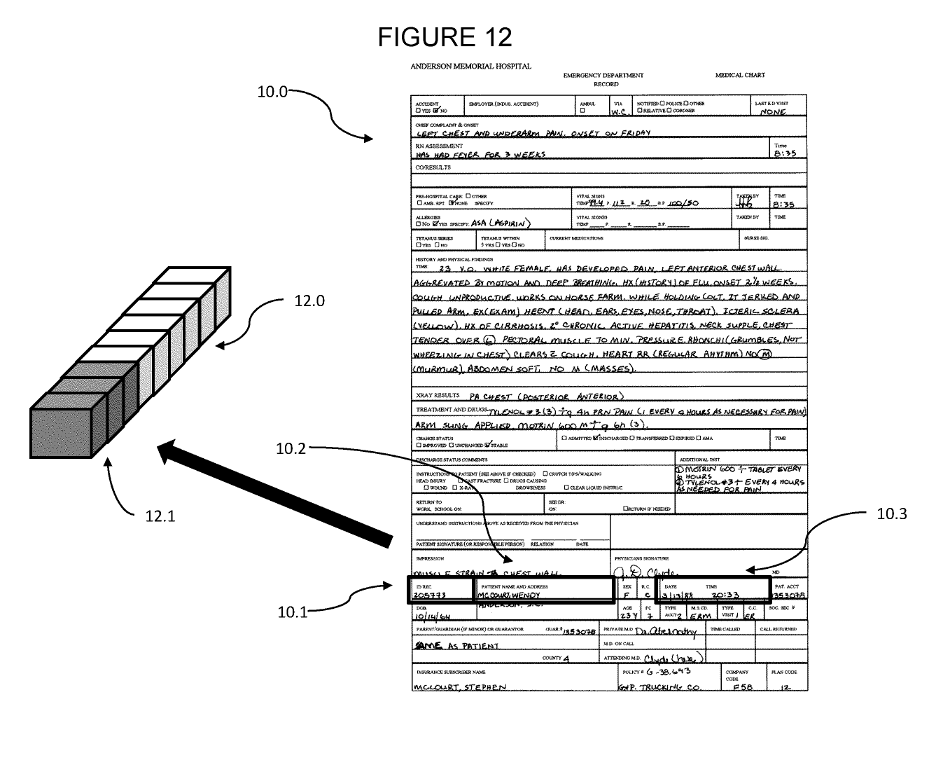

For example, and with added reference to FIG. 12, the template generated for item 10.0 of a first type will have associated with it a one-dimensional array 12.0 for each occurrence of this file type in the project as a whole, in which the first three cells 12.1 will be set to correspond with the extracted elements 10.1, 10.2 and 10.3 defined by the item type's associated template, and in which the remaining cells will be left unassigned.

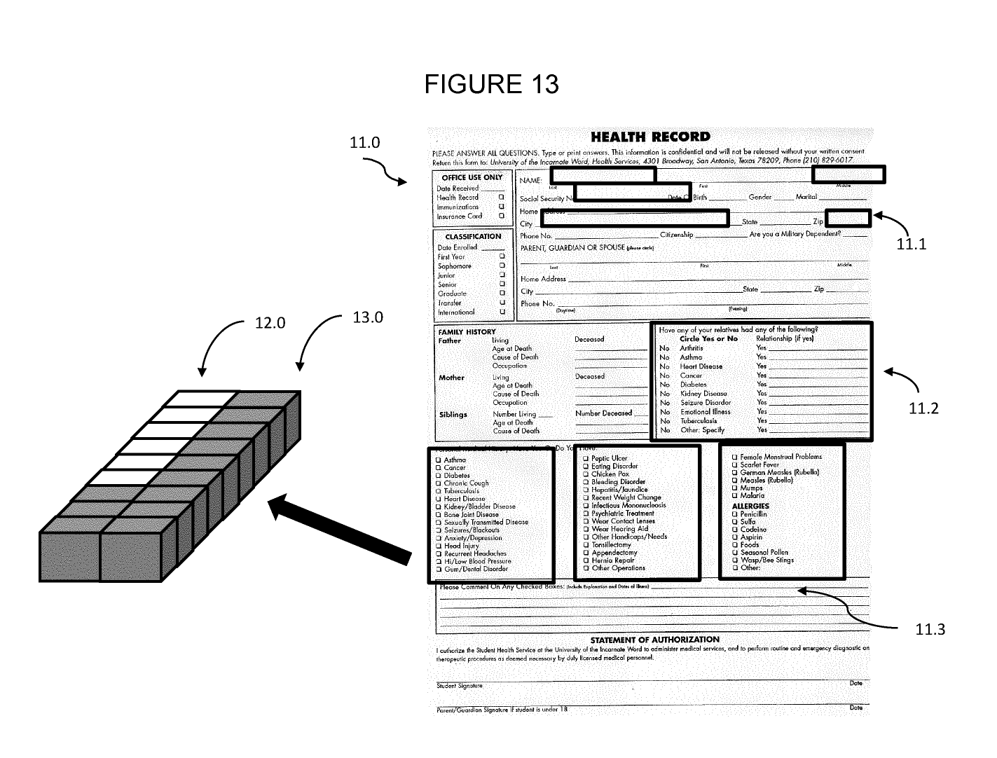

With added reference to FIG. 13, juxtaposed to the arrays 12.0 associated with each content item of the first type will be a respective one-dimensional array 13.0 corresponding to each occurrence of the second file type 11.0. In this case, the template for the second file type defines nine (9) segment extractions, which also coincides in this example to the maximum number of segment extractions for any file type in this project. Accordingly, all cells are assigned to a corresponding content extraction and none are left unassigned.

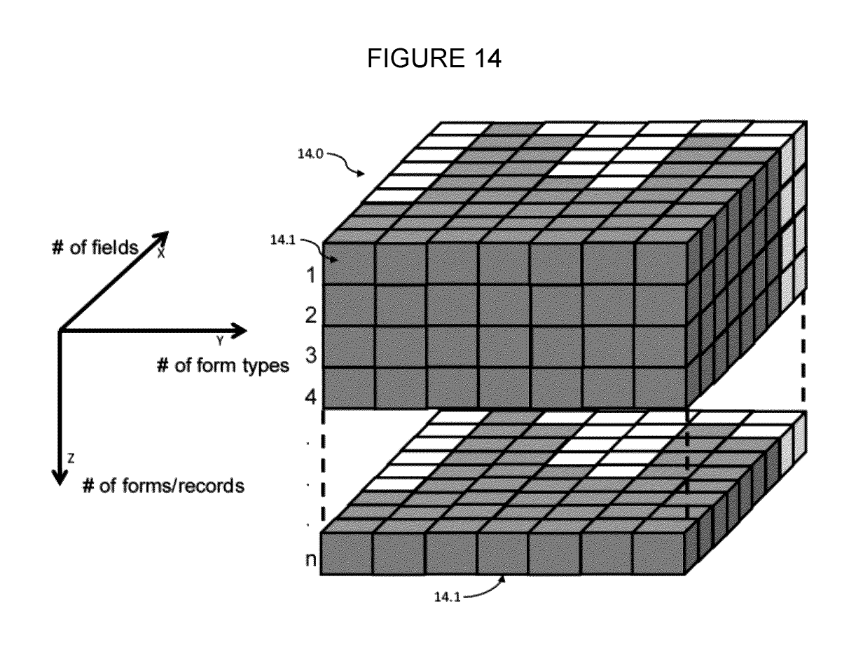

With added reference to FIG. 14, a three-dimensional array 14.0 can thus be created to reference each extracted content element, such as segments 14.1 (e.g. fields 1 to a maximum of 9 in this example, as listed along the y-axis), from each file type (i.e. seven file types identified in this example along the x-axis), and for each file, record or form (e.g. files 1 to n in this example as listed along the z-axis).

In some embodiments, a set of two-dimensional arrays can be created in lieu of the three-dimensional array discussed above. For example, a first two-dimensional array may be used to store data on the different content item types, such as the number of content elements and the location of each content element within each content item type. Another two-dimensional array may be used to store data on the different files/content items to be characterized, such as the name of the content item, the content item type and the storage location of the content item within the intake digital data storage device. Finally, another two-dimensional array may be used to store data that provides the required references for each extracted content element. Using this combination of two-dimensional arrays, a similar result may be achieved, but in some circumstances, may result in a reduction in the potentially burdensome population and processing of dummy elements (discussed below) without unduly reducing the encryption power of the proposed process.

As will be appreciated by the skilled artisan, while a three-dimensional array is contemplated in the illustrated example, other data structures and organizations may be considered to achieve a similar effect, much as the distinct two-dimensional arrays noted above or again in the formation of different one-dimensional arrays structured to provide similar results. Accordingly, these and other such data structures and organizations will be understood by the skilled artisan to fall within the general scope and nature of the present disclosure.

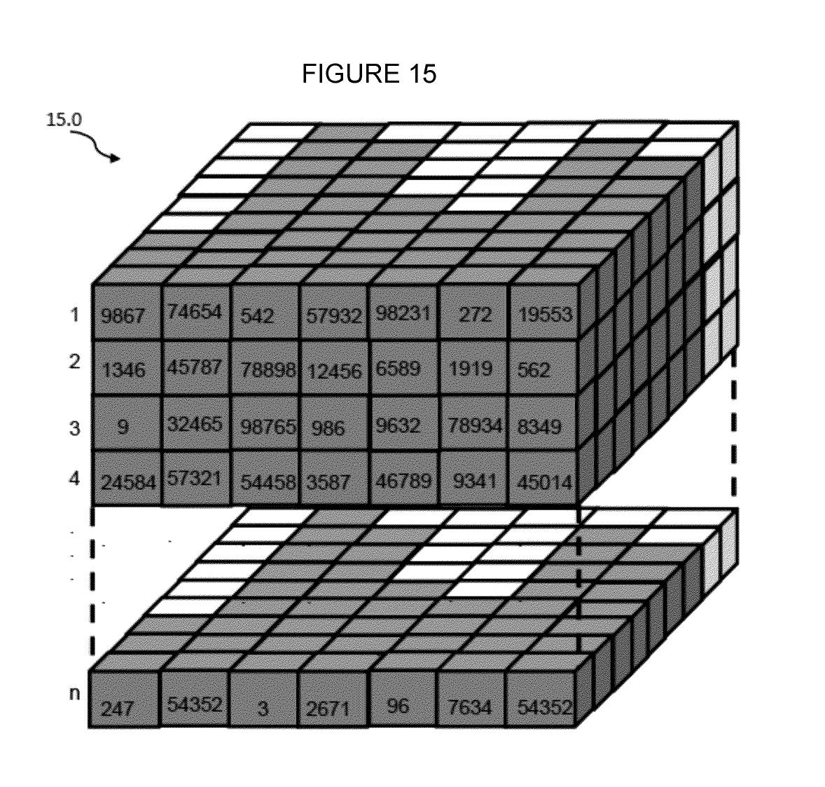

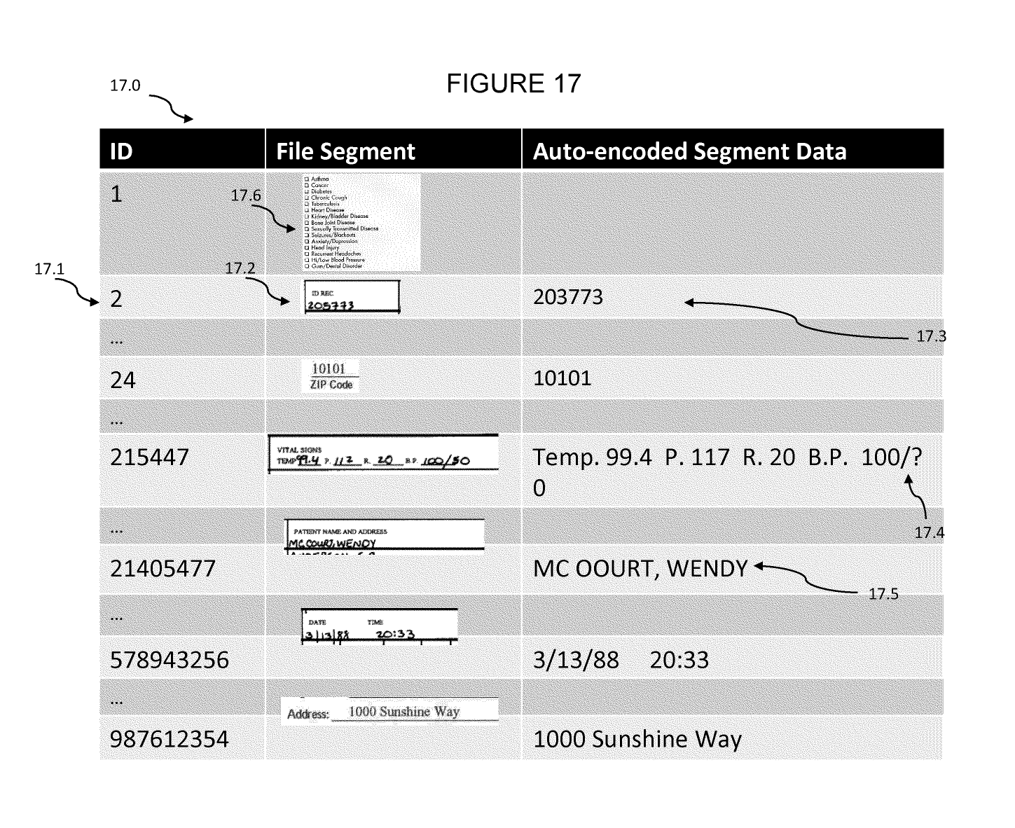

Continuing with the three-dimensional array example, and with reference again to FIG. 3, the System Operator populates at step 3.3 the three-dimensional array defined at step 3.2 with unique, randomly generated numbers (e.g. see populated array 15.0 of FIG. 15) to generate a unique key code used to encrypt and decrypt the elements to be extracted from the file items. At step 3.4, the System Operator creates a two-dimensional array that combines in numerical order each unique randomly generated number defined at step 3.3 with additional data such as the corresponding extracted content element to which it refers as per the key code matrix, and in some embodiments, an automatically generated characterization thereof for at least some of the extracted segments (e.g. as shown by array 17.0 of FIG. 17).

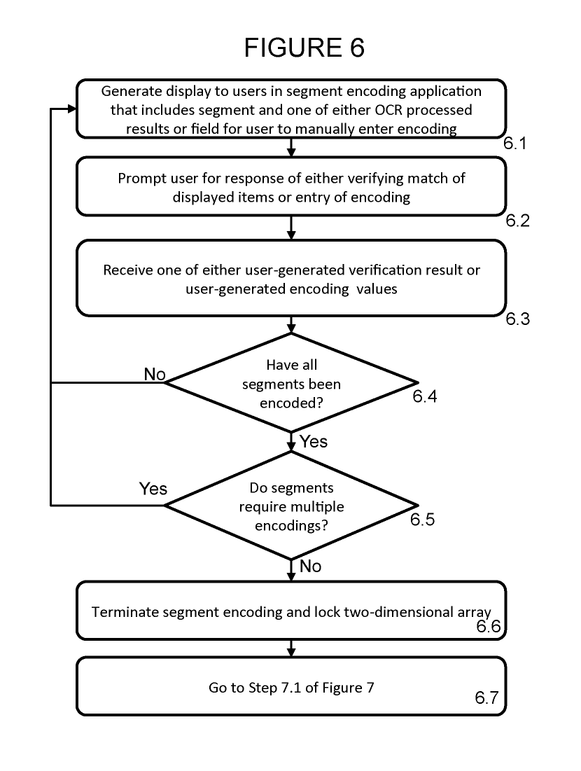

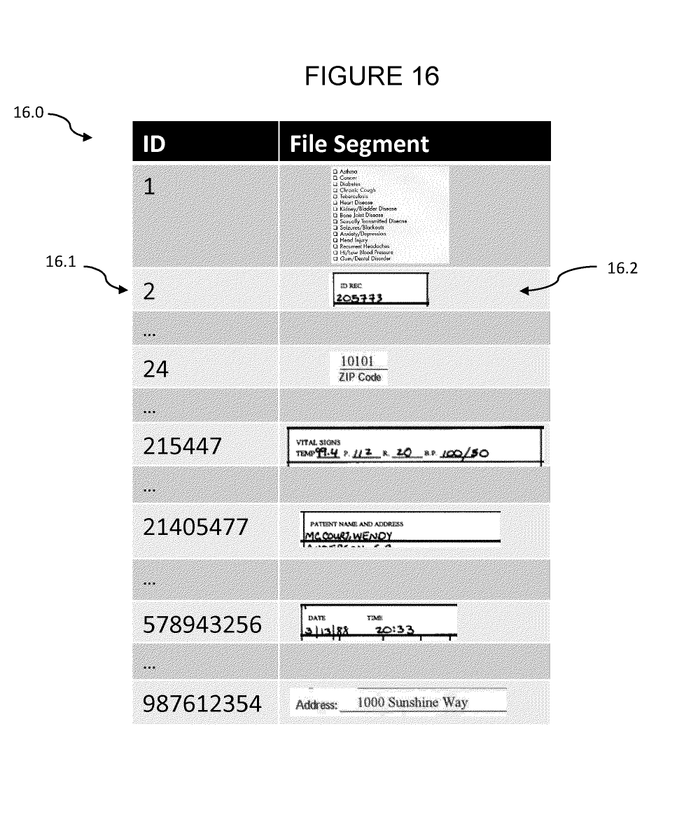

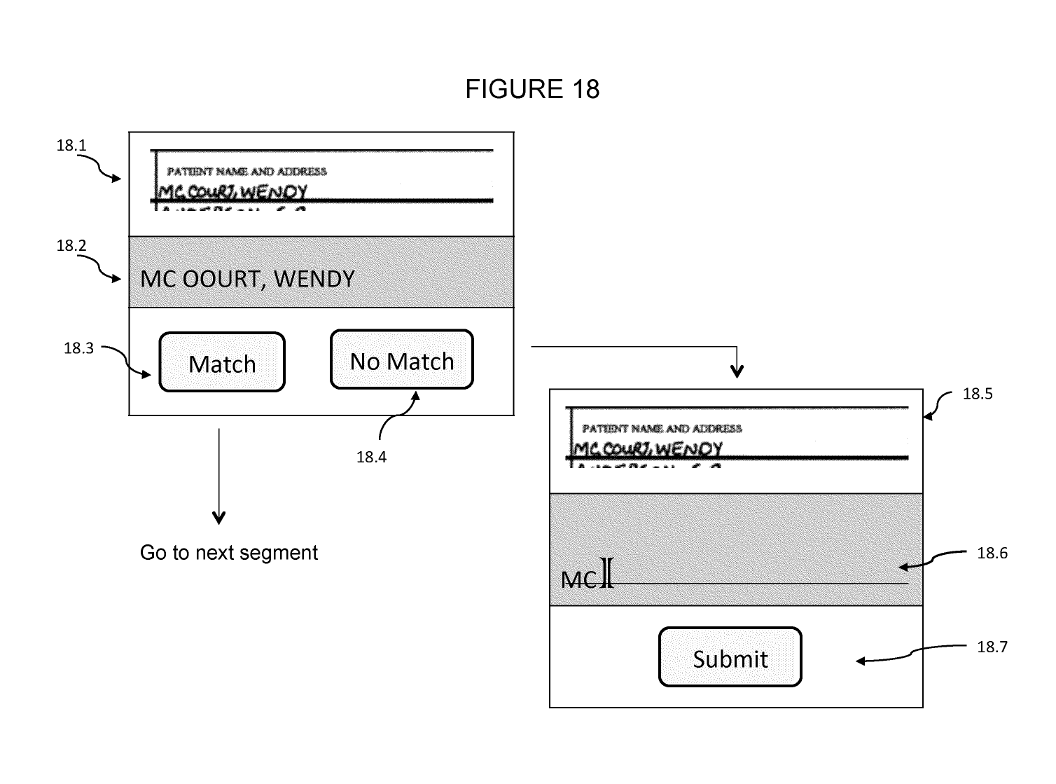

For example, 2D array 16.0 of FIG. 16 illustrates combination of numerically ordered and randomly generated segment ID numbers 16.1 with their corresponding segment extractions 16.2. In the example of FIG. 17, however, the 2D array 17.0 not only includes combination of ID numbers (e.g. ID number 17.1) and corresponding element extractions 17.2, but also includes corresponding auto-encoded segment data 17.3 for at least some of the content element extractions, to be discussed in greater detail below with reference to FIGS. 6 and 18.

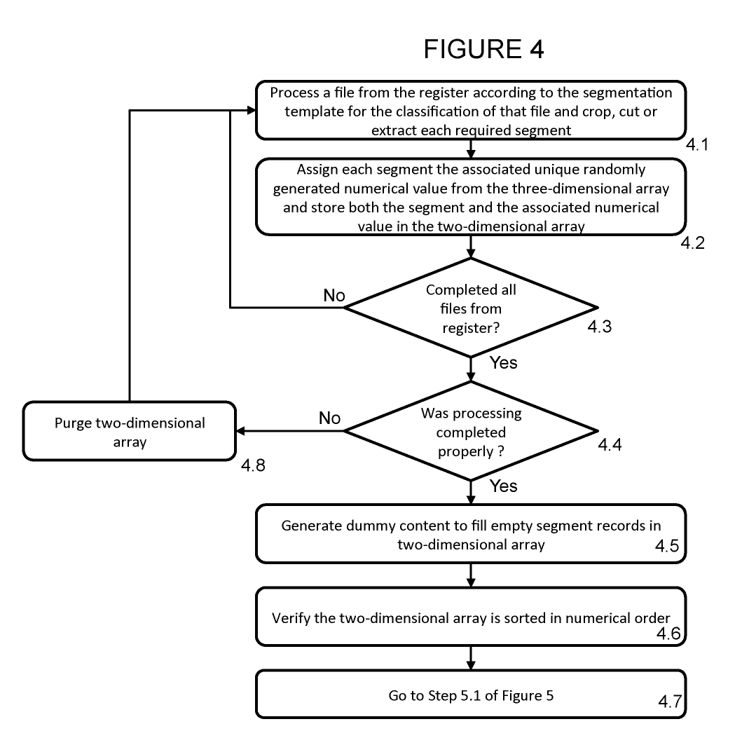

At step 3.5, the System Operator determines if there are data security concerns held by the Client. If concerns exist, the System Operator provides at step 3.6 to the Client the three-dimensional array complied at step 3.2 to be retained onsite. Otherwise, the array may be transported offsite to complete the processing remotely, as appropriate. The process for generating extracted content elements, generally referred to at step 3.7, to be used in the characterization process, will be described with reference to FIG. 4.

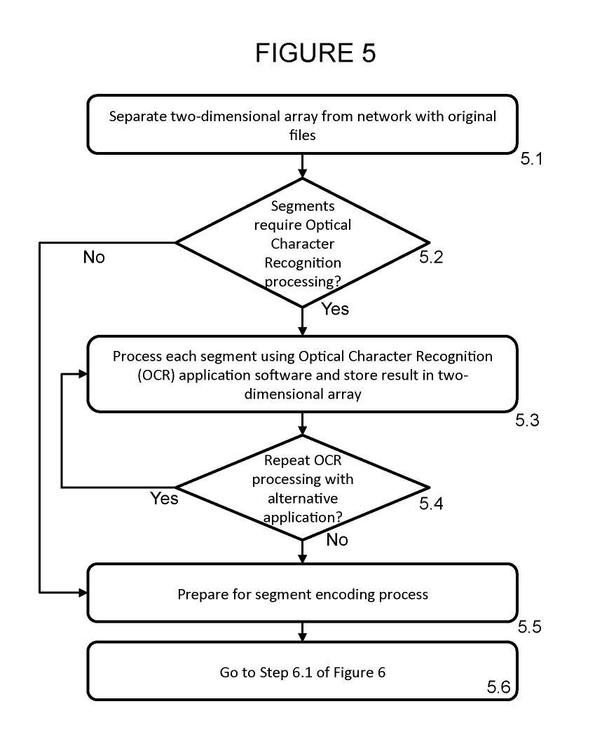

With added reference to FIG. 4, a process to segment the digitally formatted files to permit encoding/characterization of the content thereof will now be described, in accordance with one embodiment. A first content item is processed at step 4.1 from the register compiled at step 2.4, from which template-designated elements are cropped, cut, copied or otherwise extracted according to the segmentation template defined at step 2.3 for the classification of the first content item. For example, a content element extraction engine may be implemented onsite to operate on each digitized content item to extract each content element of interest as prescribed by the associated template, or as dynamically prescribed in response to a real-time element locating process. Each extracted element is associated at step 4.2 with a unique randomly generated numerical value, as defined at step 3.3 from the three-dimensional array defined at step 3.2, and both are stored in the two-dimensional array as defined at step 3.4. A check is then performed at step 4.3 to determine if all the files from the register have been processed. If not, Step 4.1 is repeated for the next item, whereas if all files have been processed, then the System Operator may optionally conduct at step 4.4 spot checks to verify that the file processing was completed properly. If the files were not properly processed, the now populated two-dimensional array is purged at step 4.8 and the entire set of files/items are reprocessed from step 4.1. Otherwise, a business application is started to generate at step 4.5 dummy content (e.g., segments unrelated to the Client) to fill empty segment records in the two-dimensional array 3.4 (e.g. for cells in the 3D dimensional array that do not correspond with any extracted content fields). The System Operator then verifies at step 4.6 that the now complete two-dimensional array is sorted in numerical order. The process for preparing the extracted elements for characterization, generally referred to at step 4.7, will be described below with reference to FIG. 5.

With added reference to FIG. 5, a process for preparing extracted content elements for encoding/characterization will now be described, in accordance with one embodiment. In this example, the System Operator separates at step 5.1 the two-dimensional array defined at step 3.4 from the network containing the original files to create a fixed break between the original digitized content items and the created segment extractions. In one illustrative implementation, the System Operator determines at step 5.2 whether the extracted segments require pre-processing through use of an Optical Character Recognition (OCR) software application, for example based upon contractual requirements with the Client and/or feasibility given the nature of the extracted contents, for example. Where required and/or feasible, the System Operator may initiate at step 5.3 the OCR software to process each segment, as appropriate, and store the result in the two-dimensional array, for example as shown in FIG. 17. The System Operator then determines at step 5.4 whether the segments require an additional round of pre-processing through an OCR software application to increase confidence in the processing. If the System Operator determines an additional round is required, step 5.3 is repeated. If the System Operator determines at step 5.2 and 5.4 that no OCR pre-processing is required, the System Operator prepares at step 5.5 the two-dimensional array, for example as shown in FIG. 16, for use in the subsequent encoding/characterization process, which, in the embodiment of FIG. 1, is to be implemented offsite on the System Operator server 1.7. Accordingly, the original content items need never leave the Client's location and, where the original 3D array is left in the hands of the Client, offsite reconstruction of the original contents from the extracted segments becomes practically impossible. The process for encoding/characterizing the segments, generally referred to at step 5.6, will be described below with reference in FIG. 6.

With added reference to FIG. 6, an extracted content element characterization process will now be described, in accordance with one embodiment. End users/participants access the segment characterization application implemented on the System Operator server 1.7 via respective terminals 1.5. In doing so, users gain access at step 6.1 to a graphical rendering (or other appropriate digital rendering depending on content format) of successive content extractions selected from the two-dimensional array generated at step 3.4 for observation/sampling (e.g. visualization) and characterization. Depending on the implementation, the user may either have access to the extracted content element alone, as identified in the array shown in FIG. 16, or in combination with an OCR or otherwise pre-processed output corresponding to that data extraction, as identified in the array shown in FIG. 17.

Accordingly, depending on the implementation and type of content extraction in question, users may be prompted for a response at step 6.2 that may entail either one of systematically entering an encoding/characterizing input, verifying the accuracy of the pre-processed characterization and otherwise providing a correction therefor, or again verifying the accuracy of another user's characterizing input (e.g. where duplicate efforts are implemented to ensure a high level of accuracy).

Following from the example of FIG. 17, where the segment extraction consists of a digitized manual data entry, the auto-encoded data may include an optical character recognition (OCR) output corresponding to that entry, which output may subsequently be verified for accuracy by a remote end user, as noted above. For example, in the case of OCR output 17.3, the auto-encoded data is actually correct and may be confirmed as such by an end user. In the case of OCR output 17.4 where at least some of the output characterization is left as questionable, an end user may rather be asked to not only confirm the accuracy of the main characterization but also provide further characterization for the questionable portion. As for OCR output 17.5, an end user should recognize the error and provide a corrected characterization. As for segment 17.6, no data can be automatically generated, and an end user can thus be asked to digitally populate an appropriate form corresponding to the extracted content element.

With reference to FIG. 18, an example of what a user may see upon accessing and interfacing with the content characterization application will now be described, in accordance with one illustrative embodiment. In this example, the user is presented with a graphical rendition 18.1 of the extracted content element in question for visualization and characterization. In this example, the user is also presented with a pre-processed characterization 18.2 of the element and asked to confirm a match therebetween (e.g. via graphically rendered button 18.3), or proceed to enter a correction (e.g. via graphically rendered button 18.4). Upon registering a match, the user proceeds to the next segment visualization and characterization. Where correction is required, the user is presented with a subsequent window 18.5 in which a digital data entry field 18.6 is provided for the user to enter a matching characterization, and submit it for processing via button 18.7.

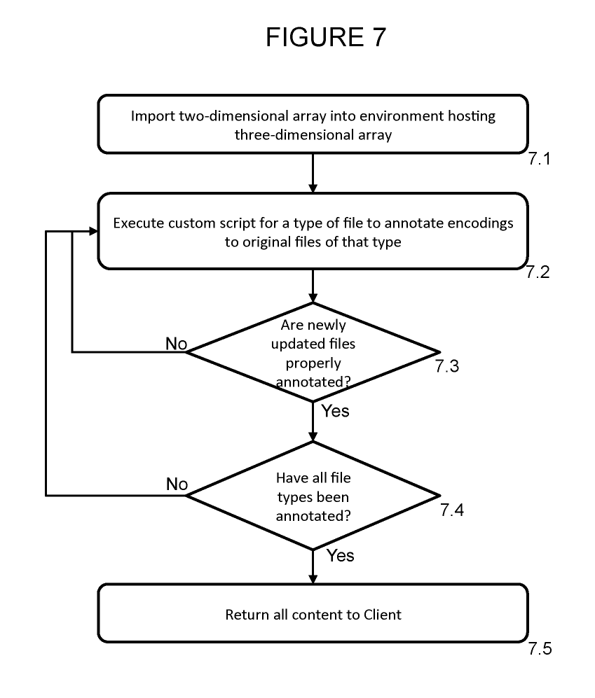

With reference again to FIG. 6, at step 6.3, the System Operator server 1.7 receives each user-generated input and stores the results in the two-dimensional array against their corresponding extracted content element. The System Operator server 1.7 determines at step 6.4 if all segments have been encoded. If they have not, the digital characterization process repeats from step 6.1 until all segments have been encoded. At step 6.5, the System Operator server 1.7 determines if any segments require multiple encodings (e.g. based on contractual obligations, prescribed accuracy metrics, etc.). If they do, the encoding process continues until all segments have received the necessary number of encodings to meet the required level of confidence. When no further encoding activities are required, the System Operator terminates at step 6.6 segment encoding capabilities and locks the two-dimensional array from further processing. The process for defragmenting the segments post characterization, generally referred to as step 6.7, will be described below with reference in FIG. 7.

With added reference now to FIG. 7, and in accordance with one embodiment, an exemplary process will now be described for defragmenting the digitally characterized segments and associate input characterizations with the original content items to enhance the properties and characteristics of the digitized files. In this example, the System Operator imports at step 7.1 the now user-populated two-dimensional array into the Client network 1.9 where the three-dimensional array is hosted. The System Operator then executes at step 7.2 a customized script for a given file type to annotate the input/verified characterizations to the original files of that type. For example, the scripts may annotate the encodings as document properties, keywords, tags, data fields, and so on, as required by the Client. The System Operator verifies at step 7.3 that the newly updated files are properly annotated. If they are not, the System Operator repeats step 7.2, otherwise the System Operator determines at step 7.4 if all file types have been annotated. If they have not, the System Operator repeats steps 7.2 to 7.4 until all file types have been completed. Once all file types have been completed, the System Operator returns at step 7.5 all contents to the Client.

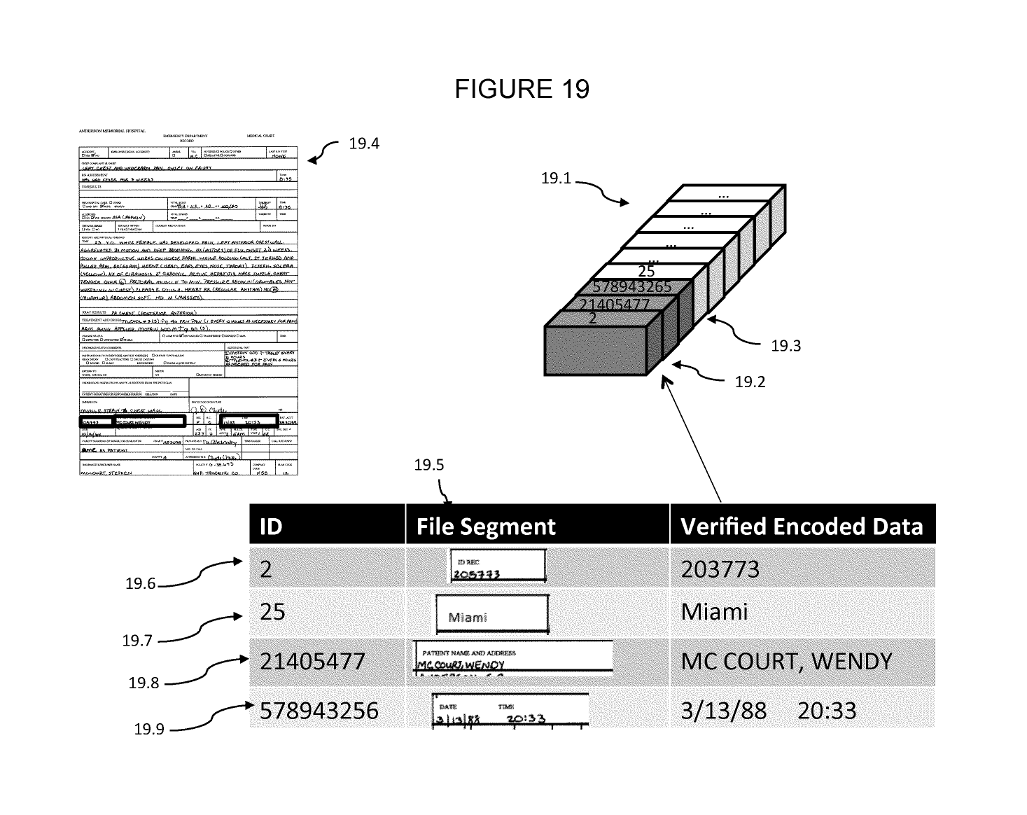

FIG. 19 provides a graphical illustration of the segment defragmentation and annotation process, as described above, for a single content item, i.e. a single row 19.1 of the three-dimensional array shown in FIG. 15. Allocated randomly generated identification numbers for the cells in this row are also provided, showing both cells corresponding to extracted elements of interest 19.2 (i.e. first three cells), and dummy cells 19.3 to be populated with unrelated data. The content item in question is also shown as a reference as item 19.4, for which three content elements of interest are illustrated as defined by the predefined template corresponding to this item's type. A corresponding two-dimensional array 19.5 is displayed with the assigned cells 19.6, 19.8 and 19.9 populated with relevant content extractions and its now associated digital input characterizations, and with dummy cell 19.7 populated with unrelated data. Upon compiling the user-characterized data against the 3D array and matching extracted content elements, and associated characterizations, with corresponding content items in the digitized file registry, digital item characterizations may be enhanced to ultimately enhance the digital value of these digitized items.

Embodiments of the present invention described herein provide the capability to process and encode electronic files, that may be confidential or contain private information, by persons whose access to confidential, private or classified information is atypical. Such persons may include youths, persons who are mentally or physically challenged, the general public, and so on. In addition, character recognition and transcription of segments does not require advanced training, thereby increasing the opportunity for persons to participate. Providing they have access to Internet telecommunications, a large number of such persons can participate in the processing and encoding of confidential or private electronic files such that the time required to complete such efforts is minimized and confidentiality is maintained.

Accordingly, embodiments of the herein-described systems and methods may be implemented through the use of otherwise generally under qualified personnel without compromising data integrity, accuracy, privacy and confidentiality. For example, in one embodiment, a register of persons enrolled as potentially able to perform content characterizations may be established and stored with the System Operator network. A degree of processing complexity may also be associated with registered users for use in allocating different processing tasks to different users. For example, low-complexity users may be asked to merely confirm matches between extracted content elements and automatically generated encodings, whereas higher-complexity users may rather be tasked with actual data entry and direct content characterizations, or again as validators/reviewers for questionable entries.

Upon initiation of the content characterization process described above with reference to FIGS. 6 and 18, suitable users may be selected and given access to the system for those files deemed appropriate given their assigned complexity or competency level, geographic location, knowledge or prior experience, accuracy ratings, etc. These individuals are then provided remote access to the system (e.g. via user credentials or the like) via the Internet address of the secure gateway, to follow from the example of FIG. 1. Upon accessing the virtual environment provided by the Service Operator network, the user may be presented randomly chosen content segments for characterization, as described above.

As introduced above, systematic controls may also be implemented to control processing of content by each individual to a particular data type or segment type, and so on. These controls could reduce the likelihood or even eliminate the possibility for any given individual from being presented segments related to the same content item and thereby increasing the level of security and confidentiality maintained by the system

Redundancy metrics may also be incorporated into the system to verify user accuracy and thus qualify an overall accuracy of the project being processed. For example, some embodiments may include the creation of additional columns in the above-described two-dimensional array to duplicate certain content characterizations and thus provide the opportunity to compare input characterizations and ascertain an accuracy of certain users, or all users overall.

In yet other embodiments, content categorizations may otherwise be provided by the public, for example within the context of a secured Web-based environment such as a game or the like. The public user could be shown the original content segment and the OCR processed result, and respond by selecting a button on their computing device indicating the two displayed items as equal or different. Multiple public users could be presented with the same original content segment and the OCR processed result to increase confidence in the accuracy of the OCR processed result. Other exemplary environments may include dedicated smartphone apps, Web-interfaces, and the like.

Ultimately, different embodiments of the above-described systems and methods may allow for the efficient and accurate digitization, cataloguing and encoding/characterization of confidential files or information by a large number of individuals without compromising privacy, security and/or confidentiality concerns, thus resulting in a more timely and cost-efficient process.

Furthermore, by providing onsite digitization services, for example using a mobile intake unit as described above, privacy and security concerns associated with the offsite manipulation of sensitive paper records may be alleviated, not to mention addressing limitations where the relocation of significant amounts of paper records offsite would be cost-prohibitive, where regular access to records is required even during the digitization process, or where the acquisition of a high-speed digital scanner is not cost-effective. Mobile onsite digitization may be particularly amenable to medical clinics and hospitals, doctor and dentist practices, financial and insurance institutions, small and medium sized businesses, libraries and museum archives, courts and legal profession offices, and governments, among others.

While the present disclosure describes various exemplary embodiments, the disclosure is not so limited. To the contrary, the disclosure is intended to cover various modifications and equivalent arrangements included within the general scope of the present disclosure.

What is claimed is:

1. A method for digitally characterizing digitized content, the method comprising:
accessing a digitized content item to be characterized;
automatically locating one or more designated content elements of interest within said digitized content item;
digitally extracting said located one or more designated content elements of interest from said digitized content item;
digitally rendering said extracted one or more designated content elements, in at least partial isolation, for systematic characterization by a user;
receiving, from said user, input of said systematic characterization for each of said extracted one or more designated content elements; and
registering each said systematic characterization as representative of its associated content element of interest to digitally characterize said digitized content item.

2. The method of claim 1, wherein the digitized content comprises multiple content items of a same type each having two or more corresponding content elements of interest, and wherein said accessing, locating and extracting comprise the steps of:
a) accessing a given content item;
b) locating a given content element of interest within said given content item;
c) extracting said given content element from said given content item;
d) repeating steps a) to c) for said given content element of interest for each of said multiple content items; and
e) repeating steps a) to d) for each of said corresponding content elements of interest.

3. The method of claim 1, wherein the digitized content comprises multiple content items of a same type each having two or more corresponding content elements of interest, and wherein said accessing, locating and extracting comprise the steps of:
a) accessing a given content item;
b) locating and extracting each of said two or more corresponding content elements of interest; and
c) repeating steps a) and b) for each of said multiple content items.

4. The method of any one of claims 1 to 3, wherein said digitized content item comprises a digitized document, and wherein said one or more content elements of interest comprise digitized manual document entries located within said digitized document that are digitally extracted and graphically rendered for visualization and characterization by the user.

5. The method of claim 4, wherein said automatically locating is implemented via a designated template corresponding to said digitized content item, and wherein said template locates designated regions on said digitized document corresponding to said one or more content elements of interest.

6. The method of claim 4 or claim 5, wherein said systematic user characterization comprises a digital user transcription input corresponding to said digitized manual document entries or a digital user confirmation input confirming accuracy of an automated transcription process for each of said digitized manual document entries.

7. The method of claim 1, wherein the method further comprises, after said accessing, identifying an item type of said digitized content item from multiple predefined item types, and wherein said automatically locating is implemented via a designated template selected to correspond to said digitized content item type.

8. The method of any one of claims 1 to 7, wherein said extracted one or more designated content elements comprise multiple content elements, wherein said digitally rendering comprises digitally rendering distinct ones of said multiple content elements for respective systematic user characterization by distinct users, and wherein said receiving comprises receiving from said distinct users, input of said respective systematic user characterization for each of said multiple content elements.

9. The method of claim 1, wherein said automatically locating is implemented via a predefined template corresponding to said digitized content item.

10. The method of any one of claims 1 to 9, wherein said digitally rendering comprises digitally rendering said extracted one or more designated content elements via a Web interface, and wherein said receiving comprises receiving said systematic characterization via user input through said Web interface.

11. The method of any one of claims 1 to 9, wherein said digitally rendering comprises digitally rendering said extracted one or more designated content elements via a remotely implemented user application interface or remote desktop application, and wherein said receiving comprises receiving said systematic characterization via user input through said remotely implemented user application interface or remote desktop application.

12. The method of any one of claims 1 to 8, further comprising before said accessing:
locating said one or more designated content elements of interest in defining a designated template corresponding to said digitized content item to be used in processing each said digitized content item.

13. The method of claim 12, wherein said designated template is defined by sequentially isolating said one or more designated content elements of interest, and wherein said automatically locating and extracting are iteratively implemented in response to each said isolating of each of said sequentially isolated content elements of interest.

14. The method of claim 12, wherein said designated template is defined by isolating said one or more designated content elements of interest in defining a combined template, and wherein said automatically locating and extracting are subsequently implemented in accordance with said combined template.

15. The method of any one of claims 1 to 14, further comprising:
after said extracting, storing said extracted content elements on a separate digital data storage device separate from an intake storage device storing said digitized content items; and
after said registering, transferring each said systematic characterization registered as representative of its associated content element of interest for association with said digitized content items on said intake storage device;
wherein said digitally rendering comprises accessing said separate digital data storage device to digitally render said extracted one or more designated content elements via a remotely implemented user application interface; and
wherein said receiving comprises receiving said systematic characterization via user input through said remotely implemented user application interface.

16. The method of any one of claims 1 to 15, wherein said digitally rendering comprises graphically rendering said extracted one or more designated content elements for visualization.

17. The method of any one of claims 1 to 15, wherein said digitized content item comprises at least one of a digital or digitized document, a digital or digitized image, a digital or digitized audio file, and a digital or digitized video file, and wherein said one or more content elements of interest comprise digital segments identifiable from said digitized content item.

18. The method of any one of claims 1 to 17, further comprising before said accessing:
digitizing hardcopy content items to produce each said digitized content item.

19. A system for digitally characterizing digitized content, the system comprising:
an intake digital data storage device having stored therein a plurality of digitized content items to be characterized;
a digital content extraction engine operatively coupled to said intake digital storage device, said extraction engine operating on each of said digitized content items to automatically locate and extract therefrom one or more designated content elements of interest;
a communication interface having operative access to said extracted content elements, said communication interface providing user interface access to an at least partially isolated digital rendering of said extracted content elements for systematic characterization; and
a digital registry communicatively linked to said communication interface to receive therefrom as input and register each said systematic characterization as representative of its associated content element of interest to digitally characterize said digitized content item.

20. The system of claim 19, further comprising a digital template corresponding to said digitized content items defining location of said one or more designated content elements of interest therein, wherein said extraction engine accesses said digital template to operate on each of said digitized content items.

21. The system of claim 19, further comprising a template generation tool operable to dynamically define location of said one or more designated content elements of interest used by said extraction engine in operating on each of said digitized content items.

22. The system of claim 21, wherein said extraction engine iteratively operates on each of said digitized content items in response to each new location defined via said template generation tool.

23. The system of claim 21, wherein said template generation tool is operable to define a combined digital template combining location for multiple content elements of interests, and wherein said extraction engine is operable to subsequently access said combined digital template to operate on each of said digitized content items.

24. The system of any one of claims 19 to 23, wherein said digitized content item comprises a digitized document, and wherein said one or more content elements of interest comprise digitized manual entries in said digitized document.

25. The system of any one of claims 20 to 23, wherein said digitized content item comprises a digitized document, wherein said one or more content elements of interest comprise digitized manual entries in said digitized document, and wherein each said location locates a designated region on said digitized document corresponding to said one or more content elements of interest.

26. The system of claim 24 or claim 25, wherein said systematic user characterization comprises a digital transcription of said digitized manual entries.

27. The system of claim 20, wherein said plurality of digitized content items are categorized according to distinct item types, wherein said data storage device stores a respective template for each of said item types, and wherein said digital content extraction engine selects, for each of said digitized content items, said respective template corresponding thereto to extract therefrom said one or more designated content elements of interest.

28. The system of any one of claims 19 to 27, wherein said extracted one or more designated content elements comprise multiple content elements, wherein said communication interface provides separate user interface access to distinct ones of said multiple content elements for systematic characterization by distinct users, respectively.

29. The system of any one of claims 19 to 28, wherein said communication interface comprises at least one of Web interface, a remote desktop interface and a remote network-accessible client application interface.

30. The system of any one of claims 19 to 29, further comprising a content intake interface operatively associated with a scanning device for digitizing hardcopy content items for storage in said digital data storage device.

31. The system of claim 30, further comprising:
a separate digital storage device, wherein said digital content extraction engine automatically segregates said extracted content elements on said separate digital data storage device to be physically handled separately from said stored digitized content items on said intake digital data storage device;
wherein said communication interface has operative access to said extracted content elements from said separate digital data storage device to provide remote user interface access to said at least partially isolated digital rendering of said extracted content elements; and
wherein said digital registry registers each said systematic characterization as representative of its associated content element of interest on said separate digital data storage device for subsequent transfer to said intake digital data storage device and association with said digitized content items.

32. The system of claim 31, wherein said separate digital storage device comprises a network accessible storage device for remote processing of said extracted content elements.

33. The system of claim 31 or claim 32, further comprising a mobile unit sized for transport within an office workspace, said housing having one or more securable compartments for securing therein a computing device operable to implement said content intake interface, said scanning device and said separate digital data storage device, wherein said extracted content elements are to be processed remotely from said office workspace without exporting said stored digitized content items.

34. The system of any one of claims 19 to 33, wherein said digitized content item comprises at least one of a digital or digitized document, a digital or digitized image, a digital or digitized audio file, and a digital or digitized video file, and wherein said one or more content elements of interest comprise digital segments identifiable from said digitized content item.

35. A method for securely distributing characterization tasks for a plurality of digitized content items across multiple users, the method comprising:
compiling a set of digital content elements for each of the plurality of digitized content items;
creating a corresponding array of randomly generated numbers, wherein said corresponding array is sized as a function of a maximum number of said content elements for any given item and a total number of said digital content items;
mapping said digital content elements to said corresponding array to automatically associate a respective one of said randomly generated numbers with each of said elements;
providing remote users access to randomly selected content elements to be digitally characterized thereby;
associating each input digital characterization with its corresponding content element; and
reconstructing each said set of now digitally characterized digital content elements based on said mapping thereby respectively characterizing each of the plurality of digitized content items.

36. The method of claim 35, wherein the plurality of digitized content items comprise different content item types, and wherein said corresponding array comprises a three-dimensional array further sized as a function of a number of said different content item types.

37. The method of claim 35, wherein the plurality of digitized content items comprise different content item types, and wherein said corresponding array comprises a set of two-dimensional arrays to accommodate said different content item types.

38. A computer-readable medium having statements and instructions stored therein for implementation by a hardware processor of a computing device in securely distributing characterization tasks for a plurality of digitized content items across multiple users by:
compiling a set of digital content elements for each of the plurality of digitized content items;
creating a corresponding array of randomly generated numbers, wherein said corresponding array is sized as a function of a maximum number of said content elements for any given item and a total number of said digital content items;
mapping said digital content elements to said corresponding array to automatically associate a respective one of said randomly generated numbers with each of said elements;
providing remote users access to randomly selected content elements to be digitally characterized thereby via a communication interface;
associating each input digital characterization received in response to said providing via said communication interface with its corresponding content element; and
reconstructing each said set of now digitally characterized digital content elements based on said mapping thereby respectively characterizing each of the plurality of digitized content items.

39. The computer-readable medium of claim 38, wherein the plurality of digitized content items comprise different content item types, and wherein said corresponding array comprises a three-dimensional array further sized as a function of a number of said different content item types.

40. The computer-readable medium of claim 38, wherein the plurality of digitized content items comprise different content item types, and wherein said corresponding array comprises a set of two-dimensional arrays to accommodate said different content item types.

41. A system for providing secure onsite digitization of paper records at a record owner's location, the apparatus comprising:
a mobile housing unit sized for transport within an office workspace, said housing having one or more securable compartments for securing therein:
an intake digital data storage device;
a hardcopy scanning device; and
a computing device having a processor operable to implement a content intake interface operatively associated with said scanning device for digitizing hardcopy content items for storage in said digital data storage device.

42. The system of claim 41, further for facilitating secure offsite characterization of said digitized content items, wherein said processor is further operable to implement:
a template generation tool for defining location of one or more designated content elements of interest in said digitized content items;
a digital content extraction engine that operates, using said template, on each of said digitized content items to locate and extract therefrom said one or more designated content elements of interest for offsite characterization; and
a digital content assignment tool for assigning with respective ones of said digitized content items, offsite characterizations associated with corresponding ones of said extracted content elements.

43. The system of claim 42, further comprising a separate digital storage device, wherein said digital content extraction engine automatically segregates said extracted content elements on said separate digital data storage device to be physically handled separately from said digitized content items on said intake digital data storage device.

44. The system of claim 43, wherein said separate digital storage device comprises a network accessible storage device for remote processing of said extracted content elements.

45. The system of any one of claims 42 to 44, wherein said intake digital storage device comprises a removable storage device that remains onsite post digitization.
